(19) United States
(12) Patent Application Publication
(10) Pub. No.: US 2007/0054658 A1
(43) Pub. Date: Mar. 8, 2007

(54) Method for downloading files onto a mobile device

(75) Inventors: David Guyard, Boulogne-Billancourt (FR); Ludovic Fouquet, Andresy (FR)

Correspondence Address: BLANK ROME LLP, 600 NEW HAMPSHIRE AVENUE, N.W., WASHINGTON, DC, 20037, US

(73) Assignee: BOUYGUES TELECOM, F-92100 BOULOGNE-BILLANCOURT (FR)

(21) Appl. No.: 10/562,316

(22) PCT Filed: Jun. 23, 2004
(86) PCT No.: PCT/FR04/01572

§ 371 Date: Apr. 25, 2006

(30) Foreign Application Priority Data
Jun. 23, 2003 (FR) 03/50246

(51) Int. Cl. H04Q 7/38; H04Q 7/22

(52) U.S. Cl. 455/414.1

(57) ABSTRACT

The invention relates to a method for downloading a digital file by a user, from a content server to a mobile terminal via a mobile telecommunication network, said method consisting of the following steps: the mobile terminal is connected to the server via the network; the file is downloaded from the server to the terminal in such a way that it is encrypted as a background task; and the file is presented to the user once the downloading has been completed. The inventive method is characterised in that: it comprises another step, before the connection step, for checking that the current time belongs to a pre-determined time slot; mechanisms for controlling the interruption of the downloading are set up, said mechanisms enabling partial versions of the file to be saved on the terminal and to then download only the missing part in the event of an interruption; the bandwidth is monitored in real time and triggers the temporary suspension of the downloading as required; and the acceptance of the content by the user once the file has been presented after being downloaded triggers the emission of an acceptance message from the terminal to the server, and the return transmission, from the server to the terminal, of a decryption message enabling the terminal to decrypt and read the downloaded file. The invention also relates to a system for carrying out the inventive method.

This invention relates to the field of mobile telecommunications.

This invention relates more specifically to a method for downloading files to a mobile apparatus such as a mobile telephone or a PDA (personal digital assistant). In the personal computer (or “PC”) environment, downloading applications provide mechanisms for managing session interruptions. However, this type of application has not yet been provided for mobile telephone or PDA environments.

The prior art already includes the German patent DE 10025725 (Bernhard Walke). This document relates to a mechanism for providing the continuity of transmission of multimedia content for a user who passes through different cells in a cellular telephone network. It primarily involves anticipating the radio connection losses and downloading enough content to avoid an interruption. This invention makes it possible to provide content to be downloaded along the user's path. This invention works well for predictable paths, such as users in a train or on a motorway.

In the patent application PCT WO 02 37369 (Nokia), a system making it possible to provide data relating to personalised rings or any, other multimedia content to a wireless portable scanner and to reproduce it on said scanner. The invention also relates to a system making it possible for a client first to view the multimedia content (a ring or a logo, for example) and to accept or reject this content, and for the client to be billed if he or she accepts this multimedia content.

The prior art also includes the patent application PCT WO 01 80518 (Motorola). This invention relates to a method making it possible to improve application protocols or sessions which use successive transmission control protocol connections within a session on time division multiple access wireless packet data systems or cable modem access protocols, wherein temporary block flows are chained. The aim of the invention presented in this document is to accelerate the transfer of Web pages and to reduce the number of direct access conflicts encountered. However, this invention does not enable session interruptions to be managed in a mobile environment.

This invention is intended to overcome the disadvantages of the prior art by proposing a method making it possible to download in a background task and to carry out billing-related operations on a mobile terminal. The invention is applicable to any mobile terminal connected to a mobile telecommunication network. This terminal is preferably GPRS-, EDGE- or UMTS-compatible.

Therefore, this invention in its most general form relates to a method for downloading a digital file by a user, from a content server to a mobile terminal, via a mobile telecommunication network, including the following steps:

connection of the mobile terminal to the server via the network;

downloading of the file from the server to the terminal in encrypted form in a background task;

presentation of the file to the user at the end of the downloading operation;

characterised in that:

it also comprises, before the connection step, a step of verifying that the current time falls within a predetermined time slot;

it implements mechanisms for managing download interruptions, which mechanisms enable partial versions of the file to be saved on the terminal and, subsequently, only the missing portion of the file to be downloaded in the event of an interruption;

it monitors the bandwidth in real time and, as necessary, causes the downloading to be temporarily suspended;

the acceptance of the content by the user after presentation of the file after downloading triggers:
the sending of an acceptance data item from the terminal to the server;
the sending in return, from the server to the terminal, of a decryption data item enabling the terminal to decipher and read the downloaded file.

The predetermined time slot preferably corresponds to low general traffic on the network.

The predetermined time slot advantageously corresponds to low data traffic on the network.

The acceptance of the content by the user after presentation of the file after downloading preferably activates the billing for the download by the server.

The mobile telecommunications network is advantageously second or third generation (GPRS, EDGE, UMTS, CDMA . . . ).

According to a specific embodiment, the mobile terminal is a mobile telephone.

According to another specific embodiment, the mobile terminal is a personal digital assistant (PDA).

Advantageously, the updating of the predetermined time slots on the terminal is performed by a connection to the server.

A download suspension is preferably triggered if the bandwidth goes below a predetermined threshold.

An attempt to restart the downloading is triggered after a predetermined time T has passed from the time tO at which the temporary download suspension was triggered.

The invention also relates to a system for implementing the method, including at least one content server and a mobile terminal mutually connected via a mobile telecommunication network.

The invention can be better understood from the following description, provided solely for the purpose of explanation, of an embodiment of the invention, with reference to the appended figures:

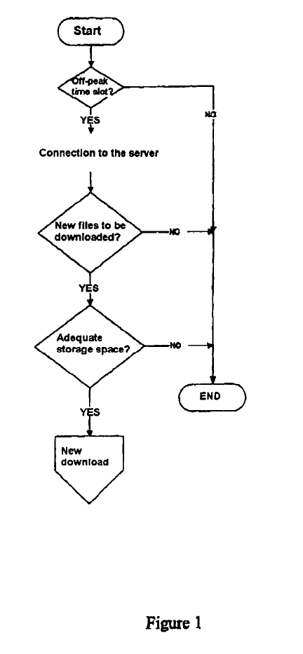

FIG. 1 shows the initialisation of the downloading operation;

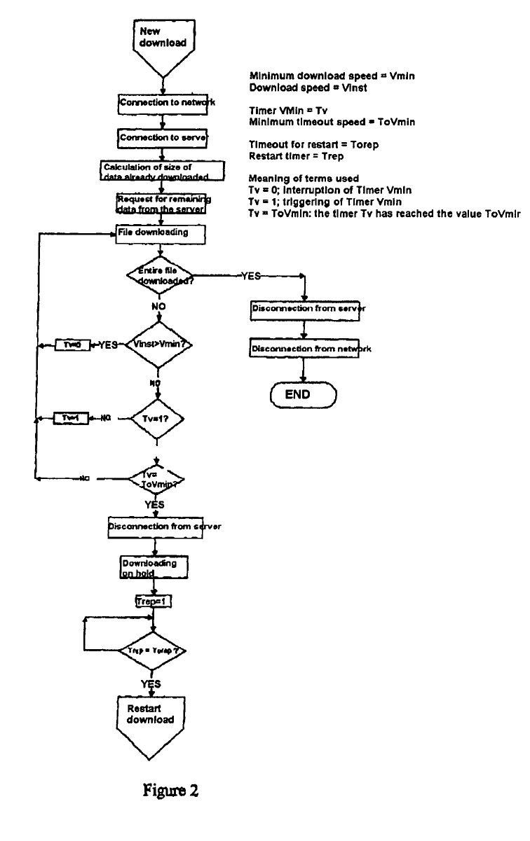

FIG. 2 shows the sequence of a new downloading operation;

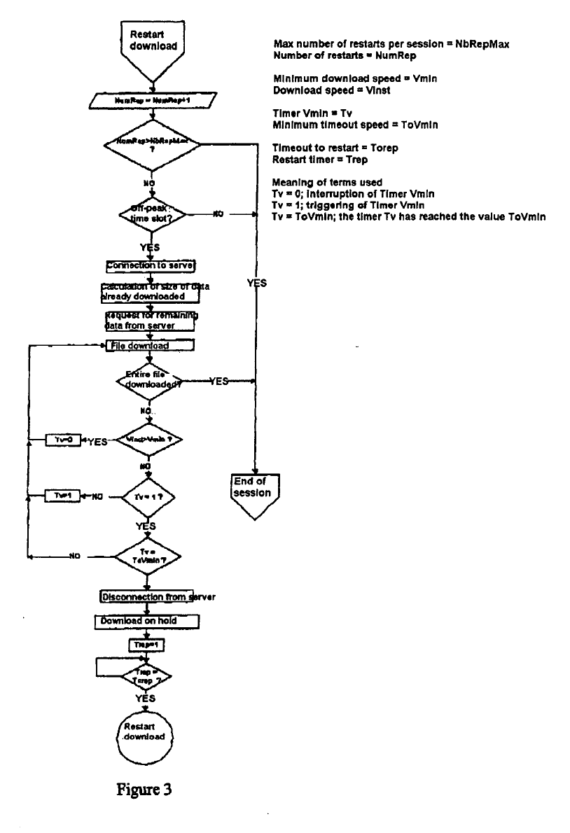

FIG. 3 shows the restarting of a downloading operation; and

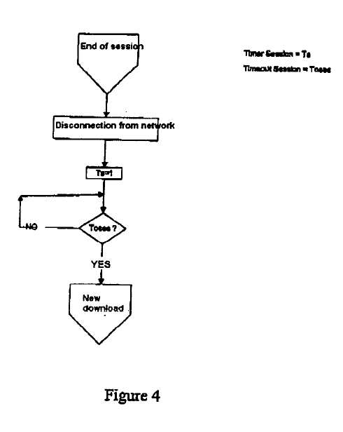

FIG. 4 shows the restarting of a downloading operation.

A user of the mobile telephone network subscribes a service distributing multimedia content, for example, audio or video content. This content may fall under various categories: news, sports, recreation, music, and so on. The mobile terminal of the subscriber includes specific software for downloading multimedia content. This software is run in a “background task”. Its operation in no way disrupts the normal use of the terminal and enables all of the other applications of the terminal to be used simultaneously. This software, which implements the method according to the invention, is programmed so as to automatically connect to a downloading server at predetermined times, without the user's intervention. It is often preferable for these “predetermined” times to correspond to low data traffic on the mobile telephone network. It is therefore appropriate to call these time slots “off-peak hours”. One of the advantages of the invention is the possibility of updating the “off-peak hours” with the client software by means of a connection to the server. Downloading during “off-peak hours” enables the use of the mobile telephone network to be optimised.

When a download takes place, the software implementing the method according to the invention monitors the downloading and its process. Several factors may cause a downloading operation to be interrupted:

entry into a zone not covered by the network;

incoming voice call;

run-down batteries;

saturation of the mobile telecommunication network;

saturation of the content server.

The transmission performance can also be adversely affected, for example, in the event of cell overload or poor coverage by the network. The software also monitors the downloading performance (flow, data wait time). If the performance is inadequate, the software orders the interruption of the downloading so as to subsequently restart it. One of the major advantages of the invention is that the restarting of the downloading operation does not mean that the downloading is started frqm the beginning. Indeed, the portion of the content already downloaded has been saved on the mobile terminal. When the downloading is restarted, only the remaining portion is downloaded.

When a file is downloaded in its entirety to the mobile terminal, the user is informed. If the service subscriber accepts this new content for use (view, read, listen), the terminal transmits a data item to the server. This data item enables the subscriber to be billed. In response to this data item, the server sends the mobile terminal a complementary data item enabling the downloaded content to be deciphered and used on the client terminal. If the user does not transmit the data item indicating that he or she accepts the content and the service is not billed by the operator, the downloaded content will remain in encrypted form on the mobile terminal.

The invention thus offers a number of advantages over the solutions known from the prior art:

optimisation of service quality: the downloading of the file is completed in spite of interruptions;

optimisation of the available bandwidth;

use of time slots during which the network is not busy;

billing for the download only after acceptance by the user;

security of the download: the file is encrypted.

The various steps of the method according to the invention can be better understood by examining the figures.

FIG. 1 shows, in detail, the initialisation phase, the three basic steps of which are:

verification that the current time falls within an off-peak time slot;

checking on the existence of new files to be downloaded;

query regarding storage space.

FIG. 2 shows the procedure carried out in a new downloading operation. In particular, this figure shows the importance of the management of time calculations and measurements for the implementation of the method according to the invention. The calculation of the size of data already downloaded is noted.

FIG. 3 shows the steps involved in restarting a downloading operation.

Finally, FIG. 4 shows the end of the session and, in particular, the disconnection from the network.

The invention is described by way of example. It is understood that a person skilled in the art is capable of implementing various alternatives of the invention without going beyond the scope of the patent.

1. Method for downloading a digital file, by a user, from a content server to a mobile terminal via a mobile telecommunication network, including the following steps:
connection of the mobile terminal to the server via the network;
downloading of the file from the server to the terminal in encrypted form in a background task;
presentation of the file to the user at the end of the downloading operation;
characterized in that:
it also comprises, before the connection step, a step of verifying that the current time falls within a predetermined time slot;
it implements mechanisms for managing download interruptions, which mechanisms enable partial versions of the file to be saved on the terminal and, subsequently, only the missing portion of the file to be downloaded in the event of an interruption;
it monitors the bandwidth in real time and, as necessary, causes the downloading to be temporarily suspended;
the acceptance of the content by the user after presentation of the file after downloading triggers:
the sending of an acceptance data item from the terminal to the server;
the sending in return, from the server to the terminal, of a decryption data item enabling the terminal to decipher and read the downloaded file.

2. Method for downloading a digital file from a content server to a mobile terminal according to claim 1, characterized in that the predetermined time slot corresponds to low general traffic on the network.

3. Method for downloading a digital file from a content server to a mobile terminal according to claim 1, characterized in that the predetermined time slot corresponds to low data traffic on the network.

4. Method for downloading a digital file from a content server to a mobile terminal according to claim 1, characterized in that the acceptance of the content by the user after presentation of the file following downloading also triggers the billing for the download by the server.

5. Method for downloading a digital file from a content server to a mobile terminal according to claim 1, characterized in that the mobile telecommunication network is second or third generation.

6. Method for downloading a digital file from a content server to a mobile terminal according to claim 1, characterized in that the mobile terminal is a mobile telephone.

7. Method for downloading a digital file from a content server to a mobile terminal according to claim 1, characterized in that the mobile terminal is a personal digital assistant.

8. Method for downloading a digital file from a content server to a mobile terminal according to claim 1, characterized in that the updating of the predetermined time slots on the terminal is carried out by means of a connection to the server.

9. Method for downloading a digital file from a content server to a mobile terminal according to claim 1, characterized in that a download suspension is triggered if the bandwidth goes below a predetermined threshold.

10. Method for downloading a digital file from a content server to a mobile terminal according to claim 1, characterized in that an attempt to restart the downloading operation is triggered after a predetermined time has passed from the time at which the temporary download suspension was triggered.

11. System for implementing the method according to claim 1 including at least one content server and a mobile terminal mutually connected via a mobile telecommunication network.
